(19) United States
(12) Patent Application Publication
(10) Pub. No.: US 2025/0252796 A1
(43) Pub. Date: Aug. 7, 2025

(54) SYSTEM FOR CONTROLLING MANAGEMENT AND ACCESS OF ENTRANTS AND OPERATING METHOD OF THE SYSTEM

(71) Applicant: ELECTRONICS AND TELECOMMUNICATIONS RESEARCH INSTITUTE, Daejeon (KR)

(72) Inventor: Seok-jin Lee, Daejeon (KR)

(21) Appl. No.: 19/046,920

(22) Filed: Feb. 6, 2025

(30) Foreign Application Priority Data
Feb. 7, 2024 (KR) 10-2024-0018884
Feb. 4, 2025 (KR) 10-2025-0013554

(51) Int. Cl. G07C 9/22; H04W 4/80

(52) U.S. Cl. CPC G07C 9/22; H04W 4/80

(57) ABSTRACT

An operating method of a system for controlling management and access of entrants is provided. The operating method includes a step of receiving, by using a first reader, unique identification (ID) data from a terminal entering an access management zone on a periphery of an entrance door according to first wireless communication and transferring the unique ID data to a management server, a step of receiving, by using a second reader, partial unique ID data of the unique ID data received from the terminal according to second wireless communication and transferring the partial unique ID data to the management server, and a step of determining, by using the management server, an access authorization of an entrant through an authentication operation including primary authentication on the unique ID data and secondary authentication on the partial unique ID data.

### CROSS-REFERENCE TO RELATED APPLICATIONS

This application claims the benefit of Korean Patent Application No. 10-2024-0018884 filed on Feb. 7, 2024 and Korean Patent Application No. 10-2025-0013554 filed on Feb. 4, 2025, which are hereby incorporated by reference as if fully set forth herein.

### BACKGROUND

### Field of the Invention

The present disclosure relates to a system for controlling management and access of entrants and an operating method of the system, and more particularly, to a system for more quickly and efficiently controlling management and access of entrants and an operating method of the system.

### Discussion of the Related Art

In modern society, a system for controlling management and access of entrants is being essentially used in various environments. Particularly, it is important to allow the entrance of only an authorized user in building entrance control, airport security, and public traffic systems and spaces such as company office, school, and research institute. Such a system for controlling management and access of entrants includes an authentication method using a proximity reader and an identification (ID) card based on radio frequency identification (RFID) or near field communication (NFC) generally.

In a general reader-based method, a user performs authentication by directly tagging an ID card or a terminal or placing it in close proximity to a reader. In such a process, the reader reads unique identifier (UID) stored in the ID card or the terminal and compares the UID with a local database of a management server to verify an access authority of a user. Such a method is high in security and enables the relatively simple configuration of hardware, and thus, is being widely adopted.

However, a conventional reader-based method enables recognition in only a specific distance and should tag an ID card or a terminal to an accurate position, and due to this, has several limitations. For example, when a user does not normally place the ID card or the terminal in close proximity to the reader or does not maintain a tagging state (a contact state) in the middle of communication, authentication may fail. Also, when there are many users, because each of the users should tag the ID card or the terminal one-by-one, there is a problem where it is difficult to perform quick authentication processing on a large number of users, and access is delayed.

### SUMMARY

An aspect of the present disclosure is directed to providing a system for controlling management and access of entrants and an operating method of the system, which may support quick authentication on a large number of users.

To achieve these and other advantages and in accordance with the purpose of the invention, as embodied and broadly described herein, there is provided an operating method of a system for controlling management and access of entrants, the operating method including a step of receiving, by using a first reader, unique identification (ID) data from a terminal entering an access management zone on a periphery of an entrance door according to first wireless communication and transferring the unique ID data to a management server, a step of receiving, by using a second reader, partial unique ID data of the unique ID data received from the terminal according to second wireless communication and transferring the partial unique ID data to the management server, and a step of determining, by using the management server, an access authorization of an entrant through an authentication operation including primary authentication on the unique ID data and secondary authentication on the partial unique ID data.

In another aspect of the present invention, there is provided a system for controlling management and access of entrants, the system including a first reader configured to receive unique identification (ID) data from a terminal entering an access management zone on a periphery of an entrance door according to first wireless communication, a second reader configured to receive partial unique ID data of the unique ID data received from the terminal according to second wireless communication, and a management server configured to determine an access authorization of an entrant through an authentication operation including primary authentication on the unique ID data received through the first reader and secondary authentication on the partial unique ID data received through the second reader.

In the present disclosure, authentication may be performed by a combination of a short-range reader and a proximity reader, and thus, an authentication processing speed may be enhanced. As a short-range reader requiring no accurate tagging performs pre-verification through primary authentication on unique ID data of a terminal, an authentication error may be reduced, and as a proximity reader performs secondary authentication by using partial unique ID data having a small data size, a tagging fail rate may decrease, and a data transmission time may be reduced, thereby enhancing an authentication processing speed.

Accordingly, an entrant authentication method according to the present disclosure may more quickly process authentication on a large number of users than a conventional method which independently uses a proximity reader.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a block diagram of a system for controlling management and access of entrants according to an embodiment of the present disclosure.

FIG. 2 is a diagram for describing a method of generating partial unique ID data according to an embodiment of the present disclosure.

FIG. 3 is a flowchart of an operating method of a system for controlling management and access of entrants according to an embodiment of the present disclosure.

FIG. 4 is a configuration diagram of a management server according to an embodiment of the present disclosure.

FIG. 5 is a configuration diagram of a short-range reader according to an embodiment of the present disclosure.

FIG. 6 is a configuration diagram of a proximity reader according to an embodiment of the present disclosure.

### DETAILED DESCRIPTION OF THE INVENTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way. The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. Also, when describing embodiments of the present disclosure, “may perform” and “may be” may include one or more embodiments of the present disclosure.

It will be understood that, although the terms first, second, etc. may be used herein to describe various elements, these elements should not be limited by these terms. These terms are used to distinguish one element from another element, and if there is no description opposite thereto, a first element may be a second element.

When “A and/or B” are/is described herein, this may denote A, B or A and B unless oppositely described. That is, “and/or” may include all combinations or an arbitrary combination of a plurality of items listed. When “C to D” are described, this may denote C or more and D or less unless oppositely described.

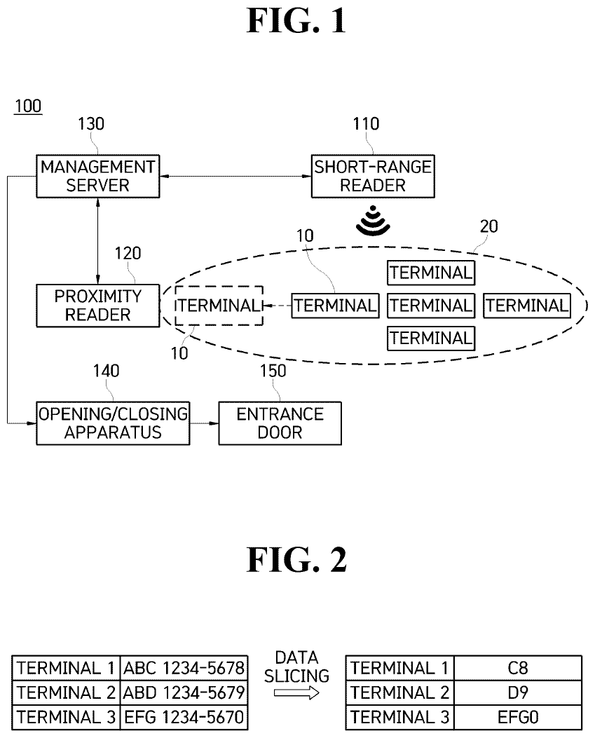

FIG. 1 is a block diagram of a system 100 for controlling management and access of entrants according to an embodiment of the present disclosure.

Referring to FIG. 1, the system 100 for controlling management and access of entrants according to an embodiment of the present disclosure may include a short-range reader 110, a proximity reader 120, and a management server 130, and moreover, may further include an opening/closing apparatus 140 which controls an opening/closing operation of an entrance door 150, based on control by the management server 130. In claims of the present disclosure, the short-range reader 110 may be referred to as a first reader, and the proximity reader 120 may be referred to as a second reader.

The short-range reader 110 may perform primary authentication on unique identification (ID) data received from a terminal 10 which has entered an access management zone 20 on the periphery of an entrance door, based on first wireless communication. The terminal 10 may be, for example, a smartphone. The proximity reader 120 may perform secondary authentication on partial data of unique ID data (hereinafter referred to as ‘partial unique ID data’) received from the terminal 10 through proximity tagging based on second wireless communication. The management server 130 may determine an access authorization through an authentication operation including the primary authentication and the secondary authentication. For example, when all of the primary authentication and the secondary authentication are successfully completed, the management server 130 may control the opening/closing apparatus 140 to release locking of the entrance door 150.

The short-range reader 110 may perform pre-verification on unique ID data of an entrant of the terminal 10 which has entered the access management zone 20, in connection with the management server 130. The first wireless communication between the short-range reader 110 and the terminal 10 may be communication which supports a maximum communication distance of tens m. This may not denote that the short-range reader 110 does not require proximity tagging. Accordingly, in the primary authentication by the short-range reader 110, authentication on a large number of users may be more quickly processed. The first wireless communication requiring no proximity tagging may include, for example, at least one of Wi-Fi communication and Bluetooth communication.

The proximity reader 120 may perform the secondary authentication by using partial unique ID data obtained through slicing of the unique ID data, in connection with the management server 130. The partial unique ID data may be less in data size than the unique ID data. Therefore, the proximity reader 120 may perform the secondary authentication by using the partial unique ID data which is less in data size than the unique ID data. The second wireless communication between the proximity reader 120 and the terminal 10 may be communication which supports a maximum communication distance of several cm. This may denote that the proximity reader 120 requires proximity tagging. Because the proximity reader 120 performs the secondary authentication by using the partial unique ID data having a small data size, a tagging fail rate and a data transmission time may be reduced. Also, the secondary authentication being performed by using the partial unique ID data having a small data size may denote that authentication may be performed in unstable communication (inaccurate proximity tagging or an insufficient tagging maintenance time). The second wireless communication may include, for example, at least one of RFID communication and NFC communication.

The management server 130 may perform the primary authentication on the unique ID data received from the short-range reader 110 and the secondary authentication on the partial unique ID data received from the proximity reader 120, and when all of the primary authentication and the secondary authentication are successfully completed, the management server 130 may transfer an access locking release signal to the opening/closing apparatus 140. The opening/closing apparatus 140 may open the entrance door 150, based on the access locking release signal.

The management server 130 may perform only the secondary authentication, based on the number of entrants entering the access management zone 20. For example, when the number of entrants entering the access management zone 20 is not large, the management server 130 may individually perform authentication based on the proximity reader 120.

The number of entrants may denote the number of terminals. The number of terminals, for example, may be checked based on unique ID data transferred through the short-range reader 110 or the number of other signals.

When the number of entrants entering the access management zone 20 is more than or equal to a reference entrant number, namely, only when there are a large number of users in the access management zone 20, the management server 130 may perform concurrent authentication including all of the primary authentication and the secondary authentication.

On the other hand, when the number of entrants entering the access management zone 20 is less than the reference entrant number, quick authentication processing on a large number of users may not be needed, and thus, the management server 130 may perform only the secondary authentication by using the proximity reader 120. At this time, the proximity reader 120 may perform the secondary authentication by using the unique ID data instead of the partial unique ID data in connection with the management server 130.

When the number of entrants entering the access management zone 20 is more than or equal to the reference entrant number, the management server 130 may slice the unique ID data according to a specific rule to generate the partial unique ID data. The management server 130 may store the partial unique ID data in a separate database which differs from a database storing the unique ID data.

To generate the partial unique ID data, the management server 130 may respectively receive first unique ID data and second unique ID data from a first terminal and a second terminal entering the access management zone 20 by using the short-range reader 110 and may compare the first unique ID data with the second unique ID data to generate, as partial unique ID data of each of the first unique ID data and the second unique ID data, the other data except overlapping data.

FIG. 2 is a diagram for describing a method of generating partial unique ID data according to an embodiment of the present disclosure.

Referring to FIG. 2, it may be assumed that three terminals enter the access management zone 20, and unique ID data of the three terminals are ‘ABC 1234-5678′, ‘ABD 1234-5679′, and ‘EFG 1234-5670′, respectively.

The management server 130 may receive three pieces of unique ID data by using the short-range reader 110, may check overlapping data in the three pieces of unique ID data, and may generate, as partial unique ID data, the other data except the overlapping data.

In the embodiment, the overlapping data may be ‘AB 1234-567′. Accordingly, partial unique ID data of a terminal 1 may be ‘C8’, partial unique ID data of a terminal 2 may be ‘D8’, and partial unique ID data of a terminal 3 may be ‘EFG0’.

As described above, because partial unique ID data is less in data size than unique ID data, a tagging fail rate and a data transmission time (a data transmission time from a terminal to a proximity reader and a data transmission time from the proximity reader to a management server) occurring in the proximity reader 120 may be reduced, and thus, authentication on a large number of users may be more quickly processed.

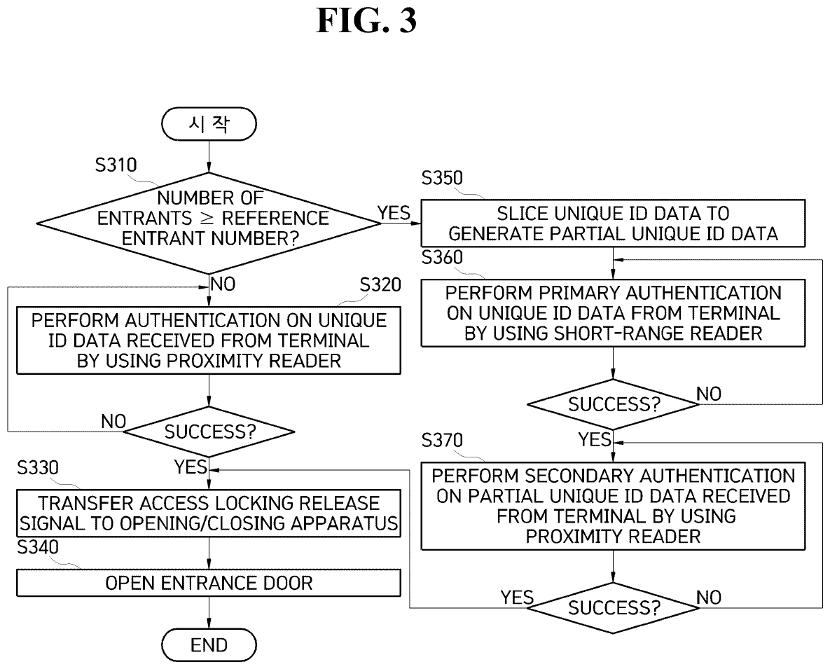

FIG. 3 is a flowchart of an operating method of a system for controlling management and access of entrants according to an embodiment of the present disclosure.

Referring to FIG. 3, first, in step S310, the management server 130 may determine whether the number of entrants entering the access management zone 20 is more than or equal to the reference entrant number. Such determination may be performed by counting the number of terminals of entrants entering the access management zone 20. The number of terminals may be checked by counting unique ID data received by the management server 130 from the short-range reader 110 or the number of other specific signals.

In step S320, when the number of entrants entering the access management zone 20 is less than the reference entrant number, the proximity server 130 may perform authentication on the unique ID data received from the terminal 10 in connection with the management server 130. Here, when the number of entrants entering the access management zone 20 is less than the reference entrant number, the proximity reader 120 may perform authentication on complete unique ID data instead of partial unique ID data.

To describe step S320 in more detail, the proximity reader 120 may transfer unique ID data, received from the terminal 10, to the management server 130 through the second wireless communication (proximity tagging), and when the management server 130 searches a database to check data matching the unique ID data transferred from the proximity reader 120, the management server 130 may successfully process authentication.

Subsequently, in step S330, the management server 130 may transfer an access locking release signal to the opening/closing apparatus 140.

Subsequently, in step S340, an entrance door may be opened based on control by the opening/closing apparatus 140. Here, the proximity reader 120 may transfer the access locking release signal to the opening/closing apparatus 140. For example, when the proximity reader 120 receives an authentication success alarm message from the management server 130, the proximity reader 120 may directly generate the access locking release signal and may transfer the access locking release signal to the opening/closing apparatus 140. The opening/closing apparatus 140 may be designed to open or close the entrance door by using an electronic or mechanical motor. The present disclosure may not be characterized by a structure of the opening/closing apparatus 140, and thus, its detailed description is omitted.

Furthermore, when the number of entrants entering the access management zone 20 is more than or equal to the reference entrant number in step S310, namely, when authentication on a large number of users is needed, step S350 may be performed.

First, in step S350, the management server 130 may slice unique ID data to generate partial unique ID data. For example, the management server 130 may compare first unique ID data of a first terminal with second unique ID data of a second terminal to generate, as partial unique ID data of each of the first unique ID data and the second unique ID data, the other data except overlapping data. The partial unique ID data may be generated in real time and may be shared by the management server 130 and the terminal 10 before step S310. When the management server 130 and the terminal 10 share the partial unique ID data before step S310, step S350 may be omitted in FIG. 3.

Subsequently, in step S360, the short-range reader 110 may perform primary authentication on unique ID data received from a terminal entering the access management zone 20, based on the first wireless communication (for example, Bluetooth, Wi-Fi, etc.). For example, the short-range reader 110 may transfer the unique ID data, received from the terminal, to the management server 130 and may compare a database with the unique ID data received from the terminal to perform the primary authentication.

When the primary authentication is successfully processed, in step S370, the proximity reader 120 may perform secondary authentication on the partial unique ID data received from the terminal through proximity tagging based on the second wireless communication (for example, RFID and NFC). For example, based on a request of the management server 130, the proximity reader 120 may request partial unique ID data from the terminal, and the terminal may transfer the partial unique ID data to the proximity reader 120 through proximity tagging, based on the request. When the proximity reader 120 receives the partial unique ID data from the terminal, the proximity reader 120 may transfer the partial unique ID data to the management server 130. The management server 130 may compare the database with the partial unique ID data received through the proximity reader 120 to perform the secondary authentication on the partial unique ID data. When the secondary authentication is successfully processed, steps S330 and S340 described above may be performed.

As described above, in a conventional entrant authentication method which individually uses a proximity reader, when a user accurately tags a terminal (an ID card) to the proximity reader, all unique ID data may be normally transmitted, and based thereon, authentication may be performed. On the other hand, when the user does not tag the terminal (the ID card) to an accurate position, authentication may fail, and tagging should be performed again. Particularly, congestion may occur in a situation where a large number of users should be authenticated. Also, as a size of unique ID data increases, an authentication time may increase. When the proximity reader manages all authentications, a processing time may be slowed, and an authentication standby time may increase.

However, in the present disclosure, authentication may be performed by a combination of a short-range reader and a proximity reader, and thus, an authentication processing speed may be enhanced. As a short-range reader requiring no accurate tagging performs pre-verification through primary authentication on unique ID data of a terminal, an authentication error may be reduced, and as a proximity reader performs secondary authentication by using partial unique ID data having a small data size, a tagging fail rate may decrease, and a data transmission time may be reduced, thereby enhancing an authentication processing speed. Accordingly, an entrant authentication method according to the present disclosure may more quickly process authentication on a large number of users than a conventional method which independently uses a proximity reader. Furthermore, an embodiment of the present disclosure may describe authentication on a terminal, but is not limited thereto and may be applied to authentication on an ID card with a communication chip embedded therein.

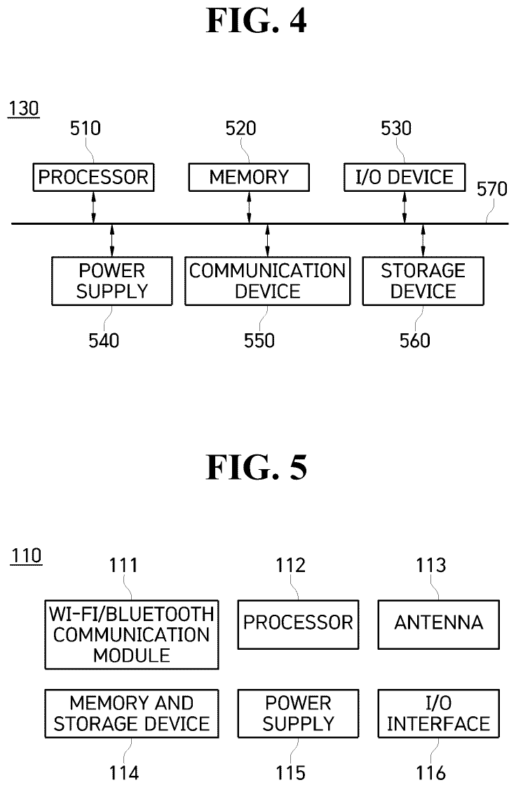

FIG. 4 is a configuration diagram of a management server 130 according to an embodiment of the present disclosure.

Referring to FIG. 4, the management server 130 may include a processor 510, a memory 520, an input/output (I/O) device 530, a power supply 540, a communication device 550, and a storage device 560, and moreover, may further include a system bus 570 which connects the elements with one another.

The processor 510 may be a device which performs a calculation and control function of a computer and may interpret and execute a command. The processor 510 may include a central processing unit (CPU) or a graphics processing unit (GPU) and may have a plurality of multi-cores or parallel calculation functions. The processor 510 may process data in connection with the memory 520 and may interact with the I/O device 530 and the communication device 550.

The processor 510 may perform an operation of slicing unique ID data received from the short-range reader 110 through the communication device 550 to generate partial unique ID data.

The processor 510 may process an operation of counting the number of unique ID data received from the short-range reader 110 to count the number of users entering an access management zone.

The processor 510 may process an operation associated with authentication on the unique ID data received from the short-range reader 110 and the partial unique ID data received from the proximity reader 120.

The memory 520 may be a device which stores data and a program executed by the processor 510 and may include a main memory and a cache memory. The main memory may include a volatile memory (for example, random access memory (RAM)) and a non-volatile memory (for example, NVRAM), and a cache may perform an operation of temporarily storing data which is frequently used for enhancing a calculation speed of the processor 510.

The I/O device 510 may manage data exchange with a user or another device. An input device may include a keyboard, a mouse, and a touch screen, and an output device may include a display device and a speaker. Some devices may simultaneously perform an input and an output like a touch screen.

The power supply 540 may be a device which supplies power to a system and may include an AC/DC converter, a battery, and an energy storage device. The power device may include a power management function which controls a voltage and a current, based on the amount of power required by a system, and increases energy efficiency.

The communication device 550 may transmit or receive data to or from an external network or another device (a short-range reader and a proximity reader). The communication device 550 may include a wired network device (for example, an Ethernet interface), a wireless network device (for example, Wi-Fi, Bluetooth, and a 5G module). Also, the communication device 550 may include a protocol conversion function and may support data exchange between different networks.

The storage device 560 may be a device which permanently stores data and a program and may include a semiconductor-based storage device (for example, solid state drive (SSD) and embedded multi-media card (eMMC)) and a magnetic storage device (for example, hard disk drive (HDD)). The storage device 560 may store a database which includes unique ID data and partial unique ID data previously shared by the terminal.

FIG. 5 is a configuration diagram of a short-range reader 110 according to an embodiment of the present disclosure.

Referring to FIG. 5, the short-range reader 110 may include a communication module 111, a processor 112, an antenna 113, a memory and storage device 114, a power supply 115, and an I/O interface 116. The communication module 111 may include a Wi-Fi module and a Bluetooth module. The Wi-Fi module may conform with IEEE 802.11 standard and may transmit or receive data over a wireless network. The Bluetooth module may support a short-range wireless communication based on IEEE 802.15.1 and may include a Bluetooth low energy (BLE) function. The processor 112 may perform an operation of processing data and analyzing and converting received information to output converted information. The processor 112 may execute firmware or an operating system (OS) of the short-range reader 120 and may manage communication with an external device. The antenna 113 may perform a function of transmitting or receiving a Wi-Fi and/or Bluetooth signal. The memory and storage device 114 may include RAM which temporarily stores data and a non-volatile memory (for example, flash memory) which retains a calculation result. The power supply 115 may operate by using a battery or an external power source and may support a low power mode so as to increase power efficiency. The I/O interface 116 may be connected to another device through a wired interface (for example, universal serial bus (USB), universal asynchronous receiver/transmitter (UART), and super path interface (SPI)).

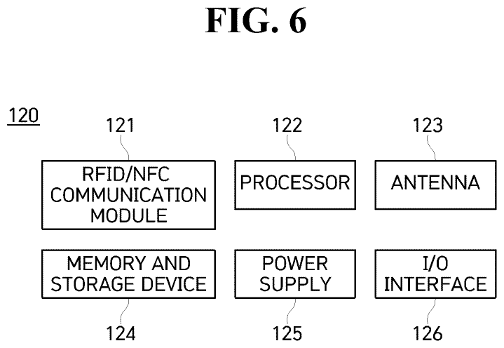

FIG. 6 is a configuration diagram of a proximity reader 120 according to an embodiment of the present disclosure.

Referring to FIG. 6, the proximity reader 120 may be a device which transmits or receives data to or from an ID device, such as a tag, a card, or a terminal including the elements, in a distance of several cm by using an RFID and/or NFC communication function.

To this end, the proximity reader 120 may include an RFID/NFC communication module 121, a processor 122, an antenna 123, a memory and storage device 124, a power supply 125, and an I/O interface 126. An RFID module, for example, may transmit or receive a wireless signal by using an ultra-high frequency (UHF) band, a high frequency (HF) band, and a low frequency (LF) band and may communicate with an active or passive tag. The NFC module, for example, may operate in a 13.56 MHz band and may exchange data with a card and a tag conforming with ISO/IEC 14443 standard and ISO/IEC 15693 standard. The processor 122 may analyze RFID and NFC signals and may convert data to perform processing. The processor 125 may perform safe data transmission by applying a security protocol (for example, AES encryption and authentication mechanism). The antenna 123 may include a coil antenna or a planar antenna, which receives the RFID and NFC signals. The memory and storage device 124 may temporarily store data (unique ID data and partial unique ID data) read from a tag, a card, or a terminal including the elements, or may use flash memory or electrically erasable programmable read-only memory (EEPROM) so as to retain an internal database. The power supply 125 may use an external power source and may use a battery or energy harvesting technology in a specific environment. The I/O interface 126 may be connected to an upper system (for example, a management server) through a wired interface (for example, I2C, SPI, and USB). The VO interface may include a function of providing a physical button, a liquid crystal display (LCD), and audio feedback.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An operating method of a system for controlling management and access of entrants, the operating method comprising:
a step of receiving, by using a first reader, unique identification (ID) data from a terminal entering an access management zone on a periphery of an entrance door according to first wireless communication and transferring the unique ID data to a management server;
a step of receiving, by using a second reader, partial unique ID data of the unique ID data received from the terminal according to second wireless communication and transferring the partial unique ID data to the management server; and
a step of determining, by using the management server, an access authorization of an entrant through an authentication operation including primary authentication on the unique ID data and secondary authentication on the partial unique ID data.

2. The operating method of claim 1, wherein a maximum communication distance of the second wireless communication is shorter than a maximum communication distance of the first wireless communication.

3. The operating method of claim 1, further comprising a step of determining, by using the management server, whether the number of entrants entering the access management zone is more than or equal to a reference entrant number, before the step of transferring the unique ID data to the management server,
wherein, when the number of entrants is less than the reference entrant number, the primary authentication is not performed.

4. The operating method of claim 3, wherein the step of determining the access authorization of the entrant comprises a step of performing authentication on the unique ID data received from the second reader when the number of entrants is less than the reference entrant number.

5. The operating method of claim 3, wherein the step of determining whether the number of entrants entering the access management zone is more than or equal to the reference entrant number comprises a step of determining whether the number of entrants is more than or equal to the reference entrant number, based on the number of unique ID data received from terminals entering the access management zone.

6. The operating method of claim 1, further comprising:
before the step of transferring the unique ID data to the management server,
a step of determining, by using the management server, whether the number of terminals entering the access management zone is more than or equal to a reference number; and
a step of, when the number of terminals is more than or equal to the reference number, slicing unique ID data received from each of the terminals to generate the partial unique ID data by using the management server.

7. The operating method of claim 6, wherein the step of generating the partial unique ID data comprises:
a step of receiving first unique ID data from a first terminal entering the access management zone;
a step of receiving second unique ID data from a second terminal entering the access management zone; and
a step of comparing the first unique ID data with the second unique ID data to generate, as partial unique ID data of each of the first unique ID data and the second unique ID data, the other data except overlapping data.

8. A system for controlling management and access of entrants, the system comprising:
a first reader configured to receive unique identification (ID) data from a terminal entering an access management zone on a periphery of an entrance door according to first wireless communication;
a second reader configured to receive partial unique ID data of the unique ID data received from the terminal according to second wireless communication; and
a management server configured to determine an access authorization of an entrant through an authentication operation including primary authentication on the unique ID data received through the first reader and secondary authentication on the partial unique ID data received through the second reader.

9. The system of claim 8, wherein a maximum communication distance of the second wireless communication is shorter than a maximum communication distance of the first wireless communication.

10. The system of claim 8, wherein the first wireless communication comprises at least one of Wi-Fi communication and Bluetooth communication, and the second wireless communication comprises at least one of radio frequency identification (RFID) communication and near field communication (NFC) communication.

11. The system of claim 8, wherein, when the number of terminals entering the access management zone is less than a reference number, the management server does not perform authentication on the unique ID data from the first reader and performs authentication on the unique ID data from the second reader.

12. The system of claim 8, wherein the management server determines whether the number of terminals entering the access management zone is less than a reference number, based on the number of unique ID data received from the first reader.

13. The system of claim 8, wherein, when the number of terminals entering the access management zone is more than or equal to a reference number, the management server slices the unique ID data received through the first reader to generate the partial unique ID data.

14. The system of claim 8, wherein the management server receives first unique ID data from a first terminal entering the access management zone through the first reader, receives second unique ID data from a second terminal entering the access management zone, and compares the first unique ID data with the second unique ID data to generate, as the partial unique ID data of each of the first unique ID data and the second unique ID data, the other data except overlapping data.
